(19) United States
(12) Patent Application Publication
(10) Pub. No.: US 2026/0277244 A1
(43) Pub. Date: Sep. 17, 2026

(54) OPERATION ROBOT

(71) Applicant: SHENZHEN HANYANG TECHNOLOGY CO., LTD., Shenzhen (CN)

(72) Inventors: Yang HUANG, Shenzhen (CN); Taotao ZHU, Shenzhen (CN); Yongqi SONG, Shenzhen (CN); Haitao LI, Shenzhen (CN)

(21) Appl. No.: 19/675,764

(22) Filed: May 13, 2026

Related U.S. Application Data
(63) Continuation of application No. PCT/CN2023/126266, filed on Oct. 24, 2023.

(30) Foreign Application Priority Data
Jun. 16, 2023 (CN) 202310724634.0
Jun. 16, 2023 (CN) 202321557190.8

(51) Int. Cl. G05D 1/672; G05D 1/221; G05D 105/00; G05D 105/15

(52) U.S. Cl. CPC G05D 1/672; G05D 1/221; G05D 2105/12; G05D 2105/15

(57) ABSTRACT

An operation robot includes a work implement and a mobile robot. The mobile robot includes a vehicle body, a support, and a drive assembly. The support is pivotally mounted to the vehicle body to allow pitching rotation, and the work implement is detachably mounted to the support. The drive assembly is mounted within the vehicle body and operatively coupled to the support through a linkage assembly. The drive assembly is configured to drive rotation of the support to cause the work implement to perform a pitching motion relative to the mobile robot.

### CROSS-REFERENCE TO RELATED APPLICATIONS

The present disclosure claims the priority to and benefits of PCT Application No. PCT/CN2023/126266 filed on Oct. 24, 2023, which further claims the priority to and benefits of Chinese Patent Application Nos. 202310724634.0 and 202321557190.8 both filed on Jun. 16, 2023, the contents of each of which are hereby incorporated by reference.

### TECHNICAL FIELD

The present disclosure relates to the technical field of intelligent operation apparatuses, and in particular, to an operation robot.

### BACKGROUND

At present, operation robots are usually used to replace manual operation to liberate manpower and facilitate lives of people. The operation robots generally include a moving body and an actuator device assembled to the moving body, and the functional mechanism is driven by the moving body to operate in a predetermined area. However, the current actuator device is generally fixed, and cannot satisfy diversified needs of users.

### SUMMARY

An objective of the present disclosure is to provide an operation robot for solving the technical problem that diversified needs of users may be difficult to satisfy since a work implement in an operation robot may be fixed.

In order to achieve the above objective, in some embodiments, the present disclosure provides an operation robot. The operation robot may include a work implement and a mobile robot, where the mobile robot may include a vehicle body, a support, and a drive assembly; the support may be pivotally mounted to the vehicle body to allow pitching rotation, and the work implement may be detachably mounted to the support; and the drive assembly may be mounted in the vehicle body and operatively coupled to the support, and may drive the support to rotate, so as to drive the work implement to perform a pitching motion relative to the mobile robot.

According to the operation robot provided by the embodiments of the present disclosure, the support fixing the work implement may be mounted to the vehicle body of the mobile robot, the work implement may be detachably mounted to the support, the support may be assembled to the vehicle body in a pitching manner, and the drive assembly may be assembled in the vehicle body. Thus, an overall size of the mobile robot may be reduced, an overall integration degree may be increased, the support can perform pitching motion when driven by the drive assembly, and the work implement may be driven to perform pitching motion accordingly.

During an operation process of the operation robot, the mobile robot can control the work implement to perform pitching motion according to different conditions. For example, in the presence of an obstacle, the mobile robot can control the work implement to perform upward pitching motion, and cross the obstacle without bypassing the obstacle. For example, when operation targets may be located at different heights and different angles, the mobile robot can control the work implement to perform pitching motion, and perform operation on the operation targets at different heights and different angles. For example, when the work implement may be replaced, the mobile robot may control the work implement to perform pitching motion, and may move to a height and an angle that may facilitate replacement by users, and diversified needs of the users may be satisfied.

### BRIEF DESCRIPTION OF THE DRAWINGS

To describe technical solutions in implementations of the present disclosure more clearly, accompanying drawings associated with description of the implementations may be briefly described below. It should be understood that the accompanying drawings in the following description may illustrate some implementations of the present disclosure, and those of ordinary skill in the art can derive other accompanying drawings from these accompanying drawings without creative efforts.

FIG. 1 is a schematic structural diagram of an exploded view of an operation robot according to an embodiment of the present disclosure;

FIG. 2 is a schematic structural diagram of a mobile robot of the operation robot of FIG. 1 from a perspective (where a drive assembly may be in an extended limit state);

FIG. 3 is a schematic structural diagram of a mobile robot of the operation robot of FIG. 1 from another perspective (where a drive assembly may be in a retracted limit state);

FIG. 4 is a side view of the mobile robot of the operation robot of FIG. 1 with a linear actuator extended to a limit position;

FIG. 5 is a partial enlarged view of a mounting portion of the mobile robot of FIG. 4;

FIG. 6 is a schematic diagram of a partial structure of a work implement of the operation robot of FIG. 1; and

FIG. 7 is a schematic structural diagram of an enlarged view of the work implement of FIG. 6 at portion A.

### DESCRIPTION OF REFERENCE NUMERALS

10. vehicle body; 11. side plate; 12. support beam; 13. back coupling plate; 14. bottom plate; 15. third rotary shaft; 20. support; 21. upright post; 22. mounting portion; 30. drive assembly; 40. linkage assembly; 41. first link; 413. lug plate; 42. second link; 43. first rotary shaft; 44. second rotary shaft; 200. mobile robot; 110. work implement; 311. snap-fit recess; 312. insertion post; 321. insertion hole; 322. latch; 31. output end; 16. housing; 111. opening; 411. first end of first link; 412. second end of first link; 421. first end of second link; 422. second end of second link; 23. first connecting end; 24. second connecting end; 211. first limiting surface; 212. second limiting surface; and 1000. operation robot.

### DETAILED DESCRIPTION

To make the technical solutions in the present disclosure to be better understood by those of ordinary skill in the art, the technical solutions in the implementations of the present disclosure may be clearly and completely described below with reference to the accompanying drawings in the implementations of the present disclosure. It should be understood that the described implementations are illustrative of some implementations rather than representative of all implementations of the present disclosure. Other implementations derived by those of ordinary skill in the art from the implementations of the present disclosure without creative efforts may fall within the scope of the present disclosure.

Technical solutions in the implementations of the present disclosure may be described below clearly and comprehensively in conjunction with accompanying drawings in the implementations of the present disclosure.

By replacing manual operation with intelligent operation, operation robots may bring convenience to lives of people and may also be conducive to liberation of manpower.

The operation robots generally may include a moving body and a work implement assembled to the moving body, and the work implement may be driven by the moving body to operate in a predetermined area. However, the work implement generally may be fixed, and may not satisfy diversified needs of users.

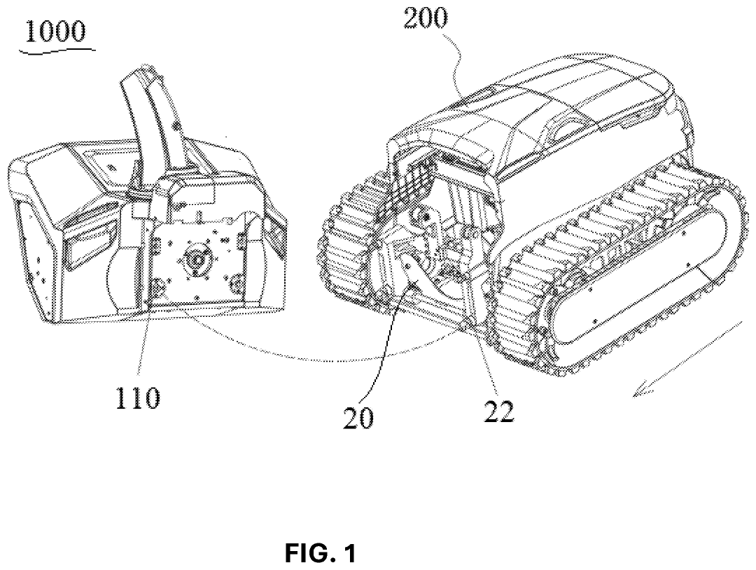

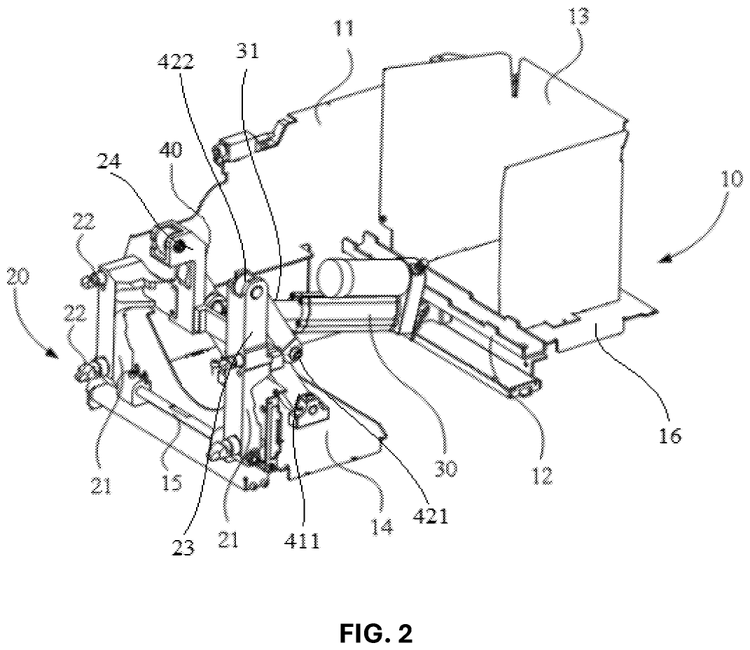

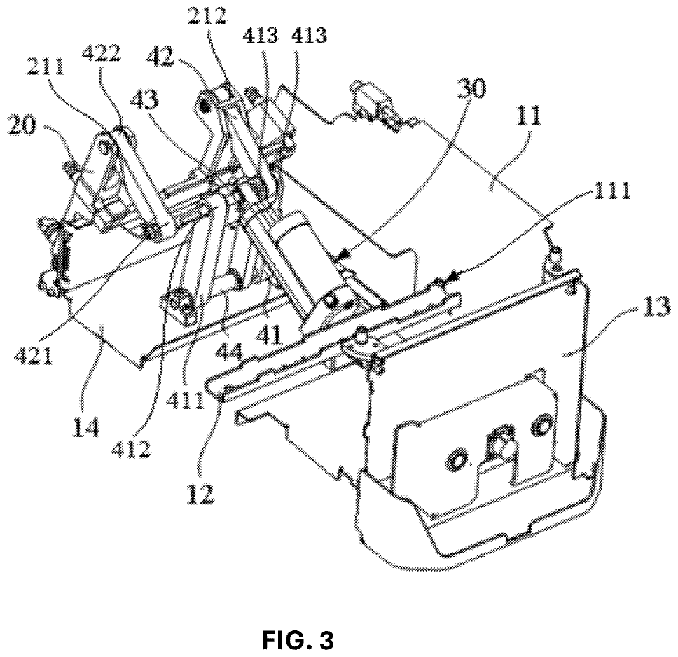

With reference to FIG. 1 to FIG. 3, the embodiments of the present disclosure may provide an operation robot 1000. The operation robot 1000 may include a work implement 110 and a mobile robot 200. The mobile robot 200 may include a vehicle body 10, a support 20, and a drive assembly 30. The work implement 110 may be detachably mounted to the support 20, and the drive assembly 30 may drive the support 20 to perform pitching motion and rotation relative to the vehicle body 10, to drive the work implement 110 fixed to the support 20 to perform pitching motion relative to the mobile robot 200. Thus, obstacle avoidance and operation at different heights and different angles may be implemented, and diversified needs of users may be satisfied.

Since the work implement 110 may be detachably mounted to the support 20, the work implement 110 or/and the mobile robot may be conveniently maintained and repaired, and the work implements 110 having different functions may be changed. In addition, since the work implement 110 may be detachable from the support 20, the same support 20 may be adapted to work implements 110 having different operation mechanisms. Thus, the operation robot 1000 may be applied to different use scenarios.

The mobile robot 200 of the operation robot 1000 of the present disclosure may be described in detail below with the operation robot 1000 applied to a yard as an example.

The vehicle body 10 may include a moving mechanism, and the moving mechanism may be a crawler traveling mechanism, or a moving chassis having wheels as long as a moving capability on ground in different environments may be achieved, which is not limited herein.

The support 20 may be configured to fix the work implement 110 to be assembled with the work implement 110 and the vehicle body 10. Support may also be provided for the work implement 110.

The pitching of the support 20 on the vehicle body 10 may be driven by the drive assembly 30. The drive assembly 30 may be mounted in the vehicle body 10. Overall integration of the mobile robot 200 may be improved, occupied space may be reduced, and an overall size of the mobile robot 200 may be reduced.

The drive assembly 30 may be operatively coupled to the support 20 and may drive the support 20 to rotate, so as to drive the work implement 110 to perform pitching motion. In some embodiments, the drive assembly 30 may include a linear actuator (which may be, for example, an electric push rod).

It should be noted that the moving body may include a Bluetooth module, a wifi module, or a real-time kinematic (RTK) module, to move in a predetermined area along a predetermined route, and may drive the work implement to operate in some implementations.

The drive assembly 30 may be a linear actuator that may have a simple and reliable driving mode and may incur a relatively low cost.

In some implementations, the support 20 fixing the work implement 110 may be mounted to the vehicle body 10 of the mobile robot 200, the support 20 may be assembled to the vehicle body 10 in a pitching manner, and the drive assembly 30 may be assembled in the vehicle body 10. Thus, an overall size of the mobile robot 200 may be reduced, an overall integration degree may be increased, the support 20 can perform pitching motion when driven by the drive assembly 30, and the work implement 110 may be driven to perform pitching motion accordingly.

During an operation process of the operation robot 1000, the mobile robot 200 may control the work implement 110 to perform pitching motion according to different conditions. For example, in the presence of an obstacle, the mobile robot 200 may control the work implement 110 to perform upward pitching motion, to cross the obstacle without bypassing the obstacle. For example, when operation targets may be located at different heights and different angles, the mobile robot 200 may control the work implement 110 to perform pitching motion, and may perform operation on the operation targets at different heights and different angles. For example, when the work implement 110 may be replaced, the mobile robot 200 may control the work implement 110 to perform pitching motion, and may move it to a height and an angle that may facilitate replacement by users, and diversified needs of the users may be satisfied.

The drive assembly 30 may be a linear actuator, and specifically, a linear actuator such as an electric push rod. The electric push rod may be rotatably mounted to the vehicle body 10, and an output end 31 of the electric push rod may be operatively coupled to the support 20. In some embodiments, the drive assembly 30 may alternatively be another type of linear actuator, such as a pneumatic cylinder, a hydraulic cylinder, a linear motor, or a linear electric cylinder.

In some implementations, the vehicle body 10 may include a housing 16 and a support beam 12, and the housing 16 may have two side plates 11 oppositely arranged. The two side plates 11 each may define an opening 111, and the support beam 12 may extend through the openings 111 in two sides, to extend through the two side plates 11. The drive assembly 30 may be mounted to the support beam 12.

Specifically, the housing 16 may include a back coupling plate 13, and the two side plates 11 may be coupled to two opposite sides of the back coupling plate 13, to form enclosing coupling.

The support beam 12 may extend through the two side plates 11, and may extend out of the two side plates 11, to be erected on the housing 16. Thus, the support beam 12 may have relatively high structural strength and stability of fixation to the housing 16. A load of the support beam may be borne by the housing 16, which may improve mounting stability of the drive assembly 30 mounted to the support beam 12.

In some implementations, the support beam 12 may be located between a top and a bottom of the housing 16, which may be higher than a bottom of each side plate 11. In this way, when a stroke of the drive assembly 30 may be designed, the stroke may be set shorter to improve driving stability of the drive assembly when the drive assembly may drive the support 20 to move.

It should be understood that in a process that the drive assembly 30 may drive the support 20 to perform pitching motion, a load of the work implement 110 may be at least partially borne by the drive assembly 30. The drive assembly 30 may be mounted in a middle of the support beam 12, and a driving end may be coupled to a middle of the support 20 correspondingly. Thus, the drive assembly 30 may provide sufficient and stable driving performance and supporting performance for the support 20 to a great extent, and supporting strength and driving force for the support 20 may be substantially equal everywhere.

The drive assembly 30 may be rotatably mounted to the support beam 12. Specifically, a rotary shaft may be mounted at a lower side of the support beam 12, and the drive assembly 30 may be mounted to the rotary shaft. Thus, the drive assembly may rotate relative to the support beam 12, and flexibility of the drive assembly when driving the support 20 to move may be improved.

In order to improve the flexibility of the drive assembly 30 when driving the support 20 to move, and reduce the stroke of the drive assembly 30 and facilitate driving stability, the mobile robot 200 may include a linkage assembly 40 located between the drive assembly 30 and the support 20. The drive assembly 30 may be operatively coupled to the support 20 through the linkage assembly 40.

In this way, the drive assembly 30 may be indirectly operatively coupled to the support 20, and the flexibility of the linkage assembly 40 may reduce design complexity of a driving mechanism for driving the support 20 to perform pitching motion. Linear movement of the drive assembly 30 may be converted into circular movement of the support 20. Thus, the driving mechanism may be designed as the drive assembly 30 (which may include a linear actuator, such as an electric push rod), with a simple structure, stable operation, and low cost.

Specifically, the linkage assembly 40 may include a first link 41 and a second link 42.

A first end 411 of the first link 41 may be rotatably mounted to a bottom plate 14 of the vehicle body 10, and a second end 412 of the first link 41 may be rotatably coupled to the output end 31. A first end 421 of each of the at least one second link 42 may be rotatably mounted to the output end 31 of the linear actuator, and a second end 422 of each of the at least one second link 42 may be rotatably coupled to the support 20.

In order to facilitate mounting of the linkage assembly 40, the linkage assembly 40 may include a first rotary shaft 43, the first rotary shaft 43 may be rotatably mounted to the output end 31 of the linear actuator, the second end 412 of the first link 41 may be rotatably coupled to the first rotary shaft 43, and the first end 421 of each of the at least one second link 42 may be rotatably coupled to the first rotary shaft 43.

In this way, the linear actuator may drive the first rotary shaft 43 to move, to drive the first link 41 and the second link 42 to move and drive the support 20 to perform pitching motion.

It should be understood that in order to facilitate mounting of the first link 41, the linkage assembly 40 may include a second rotary shaft 44, the second rotary shaft 44 may be rotatably mounted to the bottom plate 14 of the vehicle body 10, and the first end 411 of the first link 41 may be rotatably coupled to the rotary shaft.

In some implementations, in order to improve operative stability of the linkage assembly 40 operating the support 20, the support 20 may have a first connecting end 23 and a second connecting end 24 that may be spaced apart from each other, and two second links 42 may be provided. The first ends 421 of the two second links 42 may be rotatably coupled to two ends of the first rotary shaft 43 respectively, and the second ends 422 of the two second links 42 may be rotatably coupled to the first connecting end 23 and the second connecting end 24 respectively. The output end 31 of the linear actuator may be located between the first ends 421 of the two second links 42.

With such arrangement, in a driving process of the drive assembly 30, the drive assembly 30 firstly may drive the first rotary shaft 43 to move, and the first rotary shaft 43 may drive the two second links 42 to move, and the first ends 421 of the two second links 42 may be rotatably coupled to the two ends of the first rotary shaft 43. Thus, the operation of the two second links 42 may be stable.

In some implementations, the two second links 42 may synchronously drive the first connecting end 23 and the second connecting end 24 of the support 20 to move, to allow the support 20 to perform pitching motion and rotation as a whole. It should be understood that two stress points of push on the support 20 may exist and may be spaced apart horizontally, such that thrust at the two sides of the support 20 may be substantially equal, and rotational stability of the support 20 in a pitching and rotation process may be facilitated.

In some implementations, in order to improve the operative stability and mounting stability between the first link 41 and the second link 42, the second end 412 of the first link 41 may have two lug plates 413 oppositely arranged, the two lug plates 413 may be rotatably coupled to the first rotary shaft 43, the first end 421 of each of the at least one second link 42 may be located between the two lug plates 413, and the two lug plates 413 may be configured to limit axial sliding of the first end 421 of each of the at least one second link 42 along the first rotary shaft 43.

In this way, the second links 42 may be limited by the two lug plates 413, and may be less likely to be separated from the first rotary shaft 43.

It should be understood that in some embodiments, coupling of one of the first links 41 to a corresponding second link 42 can be arranged according to the above embodiment, and the second link 42 and the other second link 42 may be spaced apart from each other. Thus, overall occupied space of the linkage assembly 40 may be reduced, and layout of other electrical components in the vehicle body 10 may be facilitated.

In some other embodiments, links between the two first links 41 and two corresponding second links 42 may be arranged according to the above embodiment.

In order to improve structural stability of the support 20 with the linear actuator (which may be, for example, an electric push rod) in an extended limit state, and maintain the work implement 110 in a predetermined state (a predetermined angle and/or a predetermined height) stably, in some embodiments, the support 20 may be provided with a first limiting surface 211. When the linear actuator may be extended to the extended limit position, the first limiting surface 211 may limit rotation of each of the at least one second link 42. It should be understood that each of the at least one second link 42 may be provided with a corresponding first limiting structure in limit fit with the first limiting surface 211.

For example, the second link 42 may have a front surface oriented towards the support 20, and the front surface may be the first limiting structure. When the linear actuator may be in the extended limit state, the first limiting surface 211 may be in limit fit with the front surface of the second link 42.

For example, the second link 42 may have a front surface oriented towards the support 20 and a side surface adjacent to the front surface, and the side surface may have a limiting step. The limiting step may be the first limiting structure, and when the linear actuator may be in the extended limit state, the first limiting surface 211 may be in limit fit with a step surface of the limiting step.

In this embodiment, when two second links 42 may be arranged, the limiting structure of one second link 42 may be arranged on the front surface, and the limiting structure of the other second link 42 may be arranged on the limiting step at the side surface. In this way, the two links may be in limit fit with the support 20, such that a plurality of limiting fit positions may exist between the support 20 and the linkage assembly 40, and the structural stability of the support 20 when the linear actuator may be in the extended limit state may be improved.

In order to improve structural stability of the support 20 with the linear actuator in a retracted limit state, and maintain the work implement 110 in a predetermined state (a predetermined angle and/or a predetermined height) stably, in some embodiments, the support 20 may be provided with a second limiting surface 212. When the linear actuator may be retracted to the retracted limit position, the second limiting surface 212 may limit rotation of each of the at least one second link 42. It should be understood that each of the at least one second link 42 may be provided with a corresponding second limiting structure in limit fit with the second limiting surface 212.

For example, the second link 42 may have a front surface oriented towards the support 20 and a back surface opposite the front surface, and the back surface may constitute the second limiting structure. When the linear actuator may be in the retracted limit state, the second limiting surface 212 may be in limit fit with the back surface of the second link 42.

In some implementations, two second links 42 may be arranged. The front surface and the back surface of one second link 42 may be the first limiting structure and the second limiting structure respectively. The side surface of the other second link 42 may have the limiting step, and the limiting step may be the first limiting structure.

In order to reduce driving strength of the linear actuator (e.g., an electric push rod) in an extension process and reduce energy consumption of the linear actuator, the second end of each of the at least one second link 42 may be rotatably coupled to a top of the support 20.

It should be understood that a bottom of the support 20 may be rotatably coupled to the bottom plate 14 of the vehicle body 10. In this way, when the support 20 performs pitching motion and rotation, the support may perform circular movement around a rotational coupling position (that is, a support point). That is, the farther away the coupling position between the second end of each of the at least one second link 42 and the support 20 from the bottom of the support 20 is (that is, the longer an arm of force), the smaller thrust of the at least one second link 42 driving the support 20 to rotate may be (that is, the smaller the required force may be), the lower the energy consumption of the linear actuator may become.

Based on that, the second end of each of the at least one second link 42 may be rotatably coupled to the top of the support 20, such that the energy consumption of the linear actuator may be reduced as much as possible.

In order to facilitate mounting of the support 20, a rotatable third rotary shaft 15 may be mounted to the bottom plate 14 of the vehicle body 10, and the bottom of the support 20 may be mounted to the third rotary shaft 15.

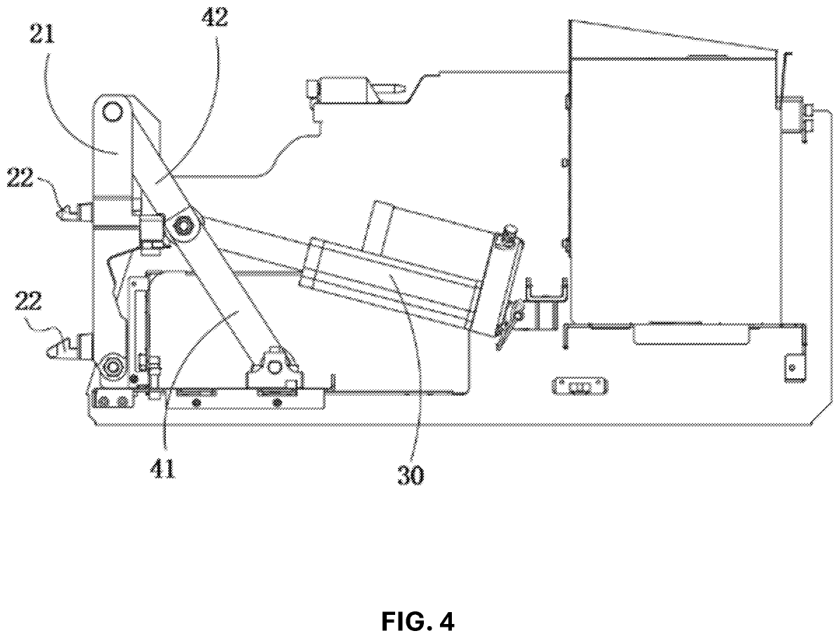

With reference to FIG. 4, in order to improve the stability of support of the support 20 by the linear actuator and the linkage assembly 40, when the linear actuator may be in the extended limit position, a center line of the first link 41 and a center line of each of the at least one second link 42 may be coplanar and may form an acute angle with the support 20. It should be understood that the first link 41 and the at least one second link 42 may be collinear to form the acute angle with the support 20, and stability of a triangle may be utilized to improve the support stability of the support 20.

Specifically, when the linear actuator may extend to the limit position, the support 20 may be perpendicular to the bottom plate 14 of the vehicle body 10.

In addition, in order to facilitate assembly and disassembly of the support 20 and the work implement 110 and replacement of different work implements 110, a side, facing away from the drive assembly 30, of the support 20 may be provided with mounting portions 22, and each mounting portion 22 may be configured to be detachably assembled with the work implement 110.

The mounting portion 22 may adopt a detachable structure, such as bolt assembly and screw assembly.

However, in this embodiment, in order to reduce assembly difficulty and improve user experience, each mounting portion 22 may be a hook. In this way, when the user assembles and disassembles the work implement 110 or replaces a different work implement 110, assembly and disassembly can be implemented through hooking or contact hooking of the hook, and the operation may be simple without using additional auxiliary tools.

In some implementations, in order to improve assembly stability of the support 20 and the work implement 110, the support 20 may have two upright posts 21 oppositely arranged, lower ends of the two upright posts 21 may be mounted to two ends of the third rotary shaft 15 respectively, and each of the two upright posts 21 may be provided with the mounting portion 22.

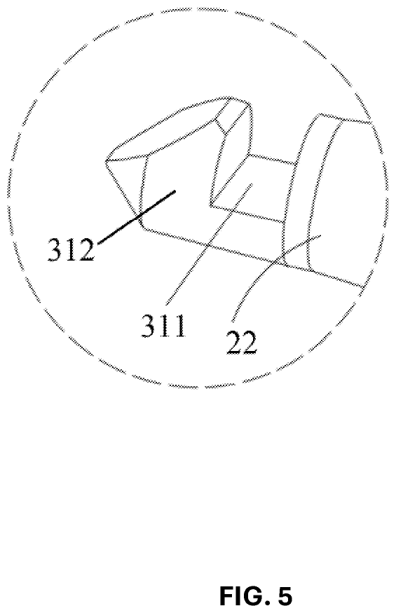

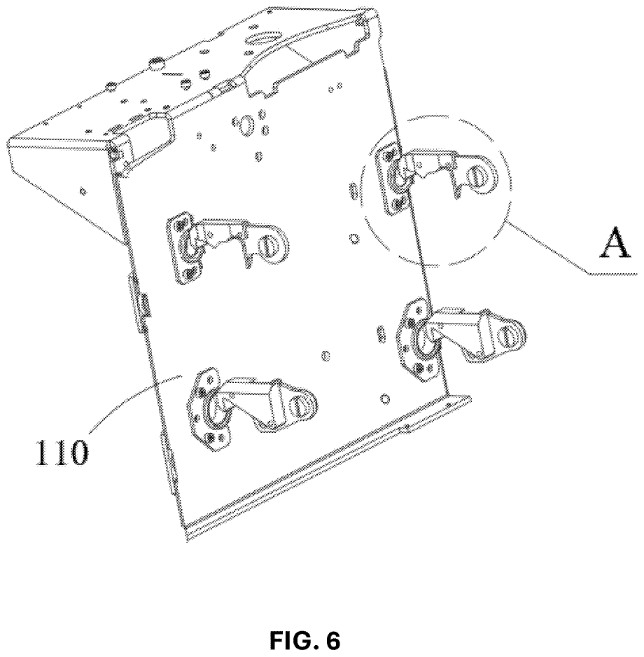

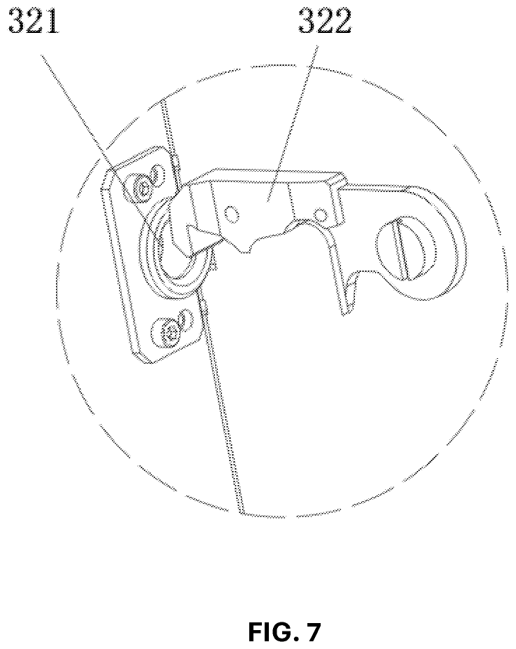

With reference to FIG. 5 to FIG. 7, in some implementations, the work implement 110 may include a machine body defining an insertion hole 321. The work implement 110 may include a latch 322 located in the machine body, and the latch 322 may be arranged adjacent to an outlet end of the insertion hole 321. Each mounting portion 22 may include an insertion post 312, the insertion post 312 may define a snap-fit recess 311, and the insertion post 312 may be insertable into the insertion hole 321, such that the latch 322 may engage the snap-fit recess 311. A hole wall of the insertion hole 321 may have a function of guiding and positioning the insertion post 312, and the latch 322 may be rotatably coupled to the work implement 110.

In some implementations, the latch 322 may be rotatably arranged to the machine body, and may have a locking position that may latch the insertion post 312 and an unlocking position that may be separated from the insertion post 312 during rotation. The machine body may be provided with a manual portion. The manual portion may be operatively coupled to the latch 322 through a corresponding linkage assembly. When the user manually drives the manual portion, the latch 322 may rotate to the unlocking position. In this case, the insertion post 312 may be completely inserted into the insertion hole 321, and then the manual portion may be released. Under an elastic member such as a tension spring, the latch 322 may automatically rotate to the locking position, thus completing snap fit between the latch 322 and the snap-fit recess 311. When disassembly is to be done, the manual portion may be manually driven, to rotate the latch 322 to the unlocking position. Thus, the latch 322 may avoid the insertion post 312, and then the insertion post 312 may be removed.

In order to improve the stability and reliability of the coupling, a plurality of mounting portions 22, a plurality of insertion holes 321, and a plurality of latches 322 may be provided. The insertion holes 321 and the latches 322 may be in one-to-one correspondence, and the mounting portions 22 and the insertion holes 321 may be in one-to-one correspondence.

The work implement 110 may be one of a snow removal implement, a lawn mowing implement, or a blower implement.

In some implementations, in order to improve the user experience and practicability, a pitching angle of the work implement 110 during pitching driven by the drive assembly 30 may range from 0 degrees to 25 degrees.

In the present disclosure, unless otherwise explicitly specified or defined, the terms such as “mounting” and “coupling” should be understood in a broad sense. For example, they may denote fixed coupling, detachable coupling, integral coupling, operative coupling, direct coupling, or indirect coupling through an intermediate medium. For those of ordinary skill in the art, specific meanings of the above terms in the present disclosure can be understood according to specific circumstances.

In addition, the terms “first,” “second,” “third,” etc. may be used for distinguishing description and should not be understood as specific indicating or a specific structure. The explanation with the phrase “in some implementations” indicates that specific features, structures, materials, or characteristics described in conjunction with the implementations or examples may be included in the implementation or example of the present disclosure. In the present disclosure, illustrative expressions of the terms do not necessarily refer to the same implementation or example. Furthermore, the specific features, structures, materials or characteristics described may be combined in any one or more implementations or examples in a suitable manner. In addition, those of ordinary skill in the art can combine and group different implementations or examples and features in different implementations or examples described in the present disclosure if there is no contradiction.

The implementations described above may be used to describe the technical solution of the present disclosure rather than limiting the same. Although the present disclosure has been described in detail with reference to the foregoing implementations, those of ordinary skill in the art should understand that the technical solution described in the foregoing implementations can still be modified, or some technical features therein can be equivalently substituted. These modifications or substitutions do not make the essence of the corresponding technical solution deviate from the spirit and scope of the technical solutions of the implementations of the present disclosure, and should fall within the protection scope of the present disclosure.

1. An operation robot comprising:
a work implement; and
a mobile robot, including:
a vehicle body having a bottom plate;
a support pivotally mounted to the vehicle body to allow pitching rotation, the work implement being detachably mounted to the support; and
a drive assembly mounted within the vehicle body, wherein the drive assembly includes an output end and is operatively coupled to the support through a linkage assembly located between the drive assembly and the support, the drive assembly being configured to drive rotation of the support via the linkage assembly to cause the work implement to perform a pitching motion relative to the mobile robot, wherein the linkage assembly includes:
a first link having a first end and a second end, wherein the first end of the first link is rotatably mounted to the bottom plate of the vehicle body, and the second end of the first link is rotatably coupled to the output end of the drive assembly; and
at least one second link having a first end and a second end, wherein the first end of each of the at least one second link is rotatably mounted to the output end of the drive assembly, and the second end of each of the at least one second link is rotatably coupled to the support.

2. The operation robot of claim 1, wherein the drive assembly comprises a linear actuator, the linear actuator being rotatably mounted to the vehicle body.

3. The operation robot of claim 2, wherein the vehicle body includes a housing and a support beam, the housing having two opposing side plates, each of the two side plates defining an opening, wherein the support beam extends through the openings of the two side plates, and wherein the drive assembly is mounted to the support beam.

4. The operation robot of claim 3, wherein the drive assembly is rotatably mounted to the support beam.

5. (canceled)

6. The operation robot of claim 1, wherein the linkage assembly comprises a first rotary shaft rotatably mounted to the output end of the drive assembly, wherein:
the second end of the first link is rotatably coupled to the first rotary shaft; and
the first end of each of the at least one second link is rotatably coupled to the first rotary shaft.

7. The operation robot of claim 6, wherein:
the support has a first connecting end and a second connecting end, the first connecting end and the second connecting end being spaced apart from each other;
the at least one second link includes two second links;
the first ends of the two second links are rotatably coupled to two ends of the first rotary shaft respectively;
the second ends of the two second links are rotatably coupled to the first connecting end and the second connecting end respectively; and
the output end of the drive assembly is located between the first ends of the two second links.

8. The operation robot of claim 6, wherein:
the second end of the first link has two oppositely arranged lug plates;
the two lug plates are rotatably coupled to the first rotary shaft;
the first end of each of the at least one second link is located between the two lug plates; and
the two lug plates are configured to limit axial sliding of the first end of each of the at least one second link along the first rotary shaft.

9. The operation robot of claim 2, wherein the support includes at least one of:
a first limiting surface configured to limit rotation of each of the at least one second link when the drive assembly extends to an extended limit position; or
a second limiting surface configured to limit rotation of each of the at least one second link when the drive assembly retracts to a retracted limit position.

10. The operation robot of claim 1, wherein:
a bottom of the support is rotatably coupled to the vehicle body; and
the second end of each of the at least one second link is rotatably coupled to a top of the support.

11. The operation robot of claim 10, wherein:
a rotatable third rotary shaft is mounted to the bottom plate of the vehicle body; and
the bottom of the support is mounted to the third rotary shaft.

12. The operation robot of claim 1, wherein:
the linkage assembly further includes a second rotary shaft rotatably mounted to the bottom plate of the vehicle body; and
the first end of the first link is rotatably coupled to the second rotary shaft.

13. The operation robot of claim 1, wherein when the drive assembly extends to an extended limit position, a center line of the first link and a center line of each of the at least one second link are coplanar and form an acute angle with the support.

14. The operation robot of claim 1, wherein when the drive assembly extends to an extended limit position, the support is perpendicular to the bottom plate of the vehicle body.

15. The operation robot of claim 1, wherein:
a side of the support facing away from the drive assembly includes at least one mounting portion; and
each of the at least one mounting portion is configured to detachably couple with the work implement.

16. The operation robot of claim 15, wherein:
the support has two oppositely arranged upright posts;
lower ends of the two upright posts are mounted to two ends of a third rotary shaft, respectively, the third rotary shaft being mounted to the bottom plate of the vehicle body; and
each of the two upright posts includes a respective mounting portion of the at least one mounting portion.

17. The operation robot of claim 16, wherein each mounting portion is a hook.

18. The operation robot of claim 15, wherein:
the work implement includes a machine body defining an insertion hole;
the work implement includes a latch located in the machine body, and the latch is arranged adjacent to an outlet end of the insertion hole; and
each of the at least one mounting portion includes an insertion post defining a snap-fit recess, the insertion post being insertable into the insertion hole such that the latch engages the snap-fit recess.

19. The operation robot of claim 1, wherein a pitching angle of the work implement during pitching driven by the drive assembly ranges from 0 degrees to 25 degrees.

20. The operation robot of claim 1, wherein the work implement is a snow removal implement, a lawn mowing implement, or a blower implement.

21. The operation robot of claim 1, further including a wireless communication component configured to receive a wireless signal, the wireless signal being configured to cause a movement of the mobile robot.
